(19) United States
(12) Patent Application Publication
(10) Pub. No.: US 2012/0092253 A1
(43) Pub. Date: Apr. 19, 2012

(54) Computer Input and Output Peripheral Device

(76) Inventors: Pourang Irani, Winnipeg (CA); Edward Mak, Winnipeg (CA); Xing-Dong Yang, Edmonton (CA)

(21) Appl. No.: 13/379,855

(22) PCT Filed: Jun. 22, 2010
(86) PCT No.: PCT/CA2010/000927

§ 371 Date: Dec. 21, 2011

Related U.S. Application Data
(60) Provisional application No. 61/219,101, filed on Jun. 22, 2009.

(51) Int. Cl. G06F 3/033; G06F 3/041

(52) U.S. Cl. 345/157

(57) ABSTRACT

The peripheral input and output device embeds a touch-screen display onto a mouse. Users interact with the display of the mouse using direct touch, whilst also performing regular cursor-based mouse interactions. The resulting device has many unique capabilities, in particular for interacting with auxiliary windows, such as toolbars, palettes, pop-ups and dialog-boxes. By migrating these windows onto a peripheral computer mouse challenges such as screen real-estate use and window management can be alleviated.

This application claims priority benefits from U.S. Provisional Application No. 61/219,101, filed Jun. 22, 2009.

### FIELD OF THE INVENTION

The present invention relates to a peripheral device for communication between a computer and a user of the computer for both input information to the computer and receiving information output from the computer, and more particularly the present invention relates to an input device for tracking a cursor movement, for example a computer mouse, which is enhanced to further comprise an interactive display incorporated therewith.

### BACKGROUND

The computer mouse is the established input device for manipulating desktop applications. Although arguably perfect in many ways, products and research have demonstrated the power in augmenting the mouse with new sensing capabilities [6, 19, 39, 9, 20]—perhaps the most successful being the scroll-wheel [20]. The fact that the mouse is so central in most peoples' everyday computing interactions makes this a potentially rich design space to explore. Predominately these explorations have focused on expanding the input capabilities of the mouse [6, 19, 39, 20, 9, 35].

Furthermore, inset windows are common in desktop applications. Some of these require immediate attention, such as system: notifications. However, several others require temporary but frequent reference by users. These include overview windows, pop-ups or previews [30, 41, 18]. These types of inset windows are used in many applications to give additional contest-sensitive information necessary for the user's task. However, they consume precious real estate on the primary display. Furthermore, they can cause additional overhead in time and effort by diverting the mouse pointer from the task at hand to interact with the window.

To overcome some of the challenges with such inset windows, designers resort to various solutions. For example, some applications keep the position of the inset window fixed to minimize occlusion of the main window (such as in a corner as in Google Maps). Alternatively, to avoid overcrowding the primary display and reduce occlusion, designers strike a balance between the size of the main window and inset displays. Other solutions include making the inset window transparent or letting users place these on a secondary display on theft desktop. However, these approaches still result in cursor movement to interact with the inset, causing users to suffer additional overhead.

Many interactive techniques rely on virtual inset windows. For example, in overview+detail view [30, 41], a small overview window takes space from the main display to provide contextual information. Overviews have proven to be useful for a variety of tasks [18, 31]. However, such techniques suffer from occlusion, and require users to move the windows around to see beneath them. Therefore, such insets are typically restricted to a small window or placed in areas of the display that are less important. Semi-transparency techniques [22, 43] were introduced to partially address occlusion problems while still maintaining a reasonable size for the inset window: However, even for moderate information densities the effectiveness of transparency is limited.

There is a long-standing trend in the prior art to augment mice with additional peripherals. Successful innovations such as the scroll-wheel have become indispensable on today's mice [20]. Other augmentations include extending the degrees-of-freedom of the mouse [6. 19], facilitating pressure input [9], and managing bi-manual interactions on the desktop [6, 25]. Pebbles [25] extends the mouse with controls on a user's external device such as a PDA and requires two hands to operate. Pebbles was not designed to display information from inset windows, nor does it couple the mouse cursor with the PDA device.

### SUMMARY OF THE INVENTION

One solution that could relieve designers from making such decisions is to embed virtual inset windows that require temporary but frequent attention on a ubiquitous input/output device such as the mouse.

According to one aspect of the invention there is provided a peripheral device for communication between a user and a computer, the peripheral device comprising:

a housing;

a tracking mechanism supported on the housing and arranged to translate a user movement into a first input signal corresponding to a movement of a cursor of the computer;

an output screen supported on the housing and arranged to display an image thereon responsive to a peripheral output signal from the computer;

a touch responsive mechanism associated with the output screen and arranged to generate a second input signal responsive to user contact with the output screen; and

electronic circuitry supported within the housing and arranged to communicate the first input signal from the tracking mechanism and the second input signal from the touch responsive mechanism to the computer and arranged to communicate the peripheral output signal from the computer to the output screen.

When used with a computer comprising a windows type graphical user interface and a primary display screen arranged to display at least one primary window to the user thereon, the output screen of the peripheral device is preferably arranged to display an auxiliary output of the windows user interface thereon, for example an inset window, a pop-up message window, a widget, a toolbar, a nested window, a hidden portion of the desktop, a preview window of a web link, a magnified portion of the primary display screen, or an interactive dialogue box.

When the tracking mechanism is arranged to determine a location of a cursor of the computer, preferably the touch responsive input mechanism of the output screen is arranged to generate the second input signal independently of the location of the cursor such that a location of the cursor is not affected by the second input signal.

The peripheral device according to the present invention is referred to herein as LensMouse, a novel device that embeds a touch-screen display or tangible “lens” onto a mouse. LensMouse can serve many purposes and functions as a multi-purpose interactive and tangible viewport for the desktop. LensMouse is well suited for alleviating some of the challenges, such as screen real-estate consumption and window management, associated with commonly used inset windows, such as overviews. Users can control the tangible viewpoint using touch on the LensMouse display without interrupting the user's main task or displacing the desktop cursor position. Various other applications LensMouse supports are also described herein. A user evaluation reveals that users are faster with LenseMouse than an insert overview, for selecting targets in a large workspace, particularly when these are occluded by the inset window.

LensMouse is a tangible and multi-purpose viewport, allowing users to directly view additional context-sensitive information without consuming screen real-estate on the primary display. Equally important is the provision of touch on the Lens Mouse display. With the index or middle finger, users can directly interact with features of the viewport. The touch-based input facilitates numerous interactions that would normally require significant mouse movements and fine control, such as minimizing/maximizing the overview or moving the cursor away from the task to control the insert. Additionally, LensMouse can be used for purposes beyond replacing inset windows, such as to see folder contents, to preview web links, to magnify pixels on the screen or to interact with dialog boxes.

When provided with a computer comprising a windows user interface and a primary display screen arranged to display at least one primary window to the user thereon, preferably the output screen is arranged to display an auxiliary output of the windows user interface thereon.

The auxiliary output may comprise an inset window, a pop-up message window, a widget, or a toolbar.

When the primary window comprises a nested window, the auxiliary output may be arranged to display contents of the nested window.

When the primary window comprises a plurality of nested windows, the auxiliary output may be arranged to display a selected one of the nested windows corresponding to a cursor location determined by the tracking mechanism.

When there is provided a plurality of primary windows including an active primary window and at least one inactive primary window overlapped by the active primary window, the auxiliary output may comprise a representation of an inactive primary window overlapped by the active primary window. Preferably the auxiliary output comprises a representation of an uppermost one of a plurality of the inactive primary windows overlapped by the active primary window.

The auxiliary output may also comprise a preview window representing contents of a web link, a magnified portion of the primary display screen corresponding to a cursor location determined by the tracking mechanism, or an interactive dialogue box.

The output screen is preferably arranged to display existing information streaming from an active application of the computer.

When the device further comprises a plug-in arranged to stream auxiliary information from an active application of the computer, the output screen is preferably arranged to display said auxiliary information.

The touch responsive mechanism may be arranged to generate the second input signal independently of the first input signal of the tracking mechanism.

When the tracking mechanism is arranged to determine a location of a cursor of the computer, preferably the touch responsive mechanism is arranged to generate the second input signal independently of the location of the cursor such that a location of the cursor is not affected by the second input signal.

Preferably the first input signal of the tracking mechanism is arranged to manipulate a first aspect of a selected object of the computer and the second input signal of the touch responsive mechanism is arranged to manipulate a second aspect of the selected object independent of the first aspect.

The touch responsive mechanism may be arranged to generate the second input signal proportionally to a user movement across the output screen.

The touch responsive mechanism may be arranged to generate a plurality of different second input signals corresponding to different designated areas of the output screen, each of the designated areas being arranged to proportionally generate the respective second input signal responsive to a user movement across the designated area of the output screen at a different rate than the other designated areas.

A function of the second input signal may be arranged to vary according to an active application being executed by the computer.

The touch responsive mechanism may include a function selection area arranged to modify the image on the output screen and a function of the second input signal responsive to user contact with the function selection area.

The touch responsive mechanism may include a button area arranged to generate a computer click input signal responsive to user contact with the button area.

The touch responsive mechanism may include a scroll area arranged to generate a scrolling input signal responsive to a user movement across the scroll area.

The touch responsive mechanism may be arranged to generate a computer click input signal responsive to a pressure of a user contact with the output screen which exceeds a prescribed pressure threshold.

Preferably the housing is arranged to be supported externally of the computer.

The housing is preferably arranged to support the tracking mechanism, the output screen, and the touch responsive mechanism integrally thereon for movement together relative to the computer.

When the housing comprises a bottom side arranged for relative sliding movement along a supporting surface in which the tracking mechanism is arranged to translate the relative sliding movement into the first input signal, the output screen is preferably arranged to extend upwardly at an inclination relative to the bottom side of the housing.

When provided in combination with a computer, preferably the computer is arranged to communicate with the peripheral device such that the image displayed on the output screen is not displayed on a primary display of the computer.

There may be provided a notification system arranged to notify a user when an image on the output screen is refreshed.

The notification system may comprise an audible notification or a vibrating notification.

Some embodiments of the invention will now be described in conjunction with the accompanying drawings in which:

### BRIEF DESCRIPTION OF THE DRAWINGS

FIG. 1 is a perspective view of a first embodiment of the peripheral device according to the present invention.

FIG. 2 is a plan view of the peripheral device showing a floating color panel window of a drawing application on the output screen of the peripheral device to reduce window management minimize on-screen occlusion on a primary display screen of the computer.

FIGS. 3(a) and 3(b) are representations of an experiment in which the instruction “bold” of FIG. 3(b) only appears after participants successfully clicked the “instruction” button which initially appears as shown in FIG. 3(a) to instruct the participant to click on the “bold” icon in the tool palette window representation.

FIG. 4 is a representation of a display screen in which near, middle and far regions are shown to represent demarcated areas based on the distance to the bottom right corner of the screen.

FIG. 5 is a graphical representation of Task completion time vs. Display Type and Number of Icons in which error bars represent +/−2 standard error.

FIG. 6 is a graphical representation of learning effects in which Task completion time vs. block number is shown.

FIGS. 7(a), 7(b) and 7(c) are schematic representations of further embodiments of the peripheral device in which FIG. 7(a) represents a rotatable display allowing most freedom in viewing positions, FIG. 7(b) represents having the display oriented towards the user, but limited by handedness, and FIG. 7(c) represents a joystick embodiment supporting an output screen for access by the thumb of the user.

FIG. 8(a) is a plan view of the peripheral device in which the output screen functions as a preview window to display contents of a folder on the primary display screen of the computer prior to opening the folder.

FIG. 8(b) is a plan view of the peripheral device in which the output screen functions as see-through window to display contents hidden on the primary display screen by an overlapping window.

FIG. 9(a) is a plan view of the peripheral device in which the output screen functions as a magnifying lens to magnify a portion of the primary display screen about the cursor so that pixel size targets are accessible by magnifying the area around the pixel.

FIG. 9(b) is a plan view of the peripheral device in which the output screen represents a full primary screen shot so that touching the output screen allows for rapidly relocating the cursor in proximity to a target which is far away so as to be otherwise cumbersome to reach.

In the drawings like characters of reference indicate corresponding parts in the different figures.

### DETAILED DESCRIPTION

Components of the LensMouse include a touch enabled display, a. notification mechanism, and a lens-bar.

Touch Enabled Display.

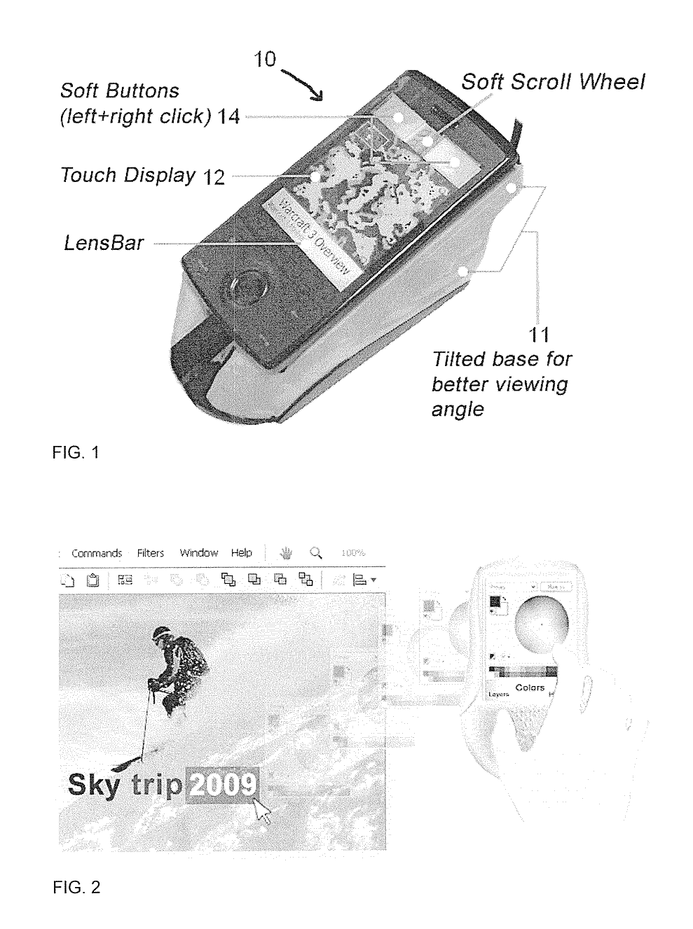

A LensMouse prototype was designed by attaching a touch-enabled smartphone (HTC touch) to the base of a typical USB mouse as shown in FIG. 1. The display is tilted toward the user to proper viewing. On the display, soft buttons were included, such as left and right button clicks, as well as a soft scroll wheel. The display provides access to inset windows that would normally consume screen real-estate on the primary display. Unlike virtual inset windows, the touch display lets users interact with information directly using the finger. Easily controllable features are accessible at the user's fingertip which eliminates the movement of the cursor from its working position when working with the inset.

Update Notifications.

Since the LensMouse display is separated from the user's main view, users are notified of important updates on the LensMouse by subtle audio cues. Additionally, the user could be notified of display updates through other modalities, such as vibrotactile feedback.

Switching “Lenses”.

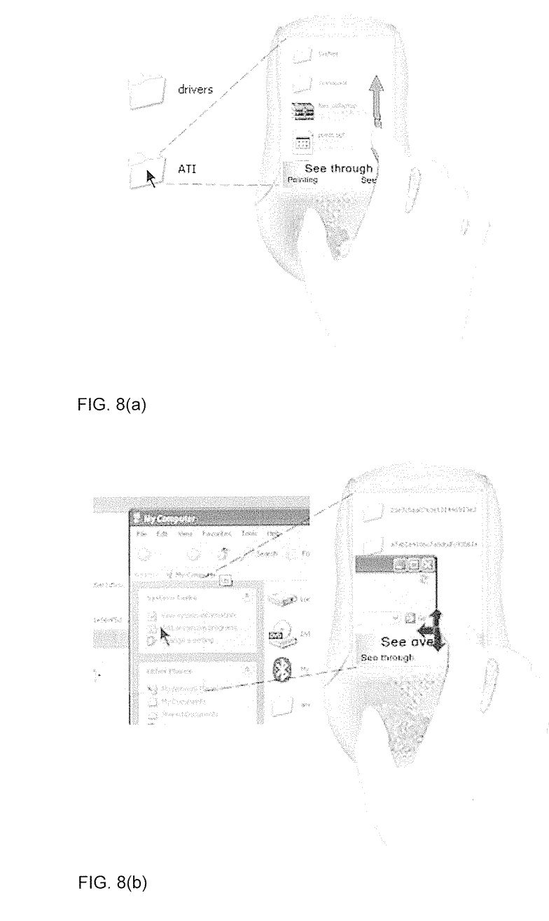

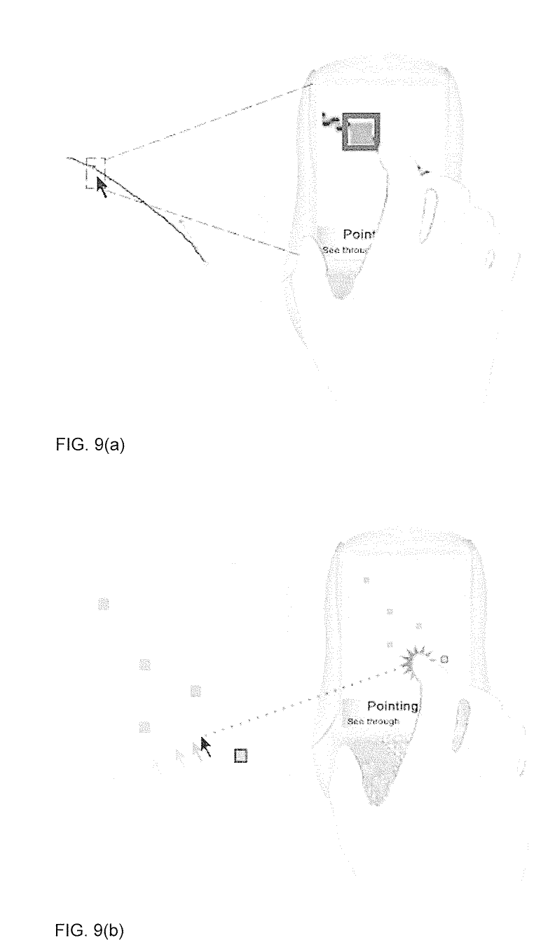

Each application can benefit from one or more useful viewpoints or “lenses”. For example, in map-based applications an overview window was included. On the Windows desktop a see-through lens and magnifying lens were provided as shown in FIGS. 8 and 9. A lens-bar was implemented in FIG. 1 that allows users to switch between lenses in an application with a single Finger tap. Successive clicks iterate through the available lenses for that given application.

The LensMouse is designed to host inset windows requiring temporary but frequent attention from users. As described in this section, LensMouse addresses some of the challenges of existing inset windows in various applications.

Reducing Mouse Trips.

Inset windows such as overviews are often placed in strategic locations, i.e. in the corner of the display. While this reduces occlusion on the main view, it also introduces significant movement of the mouse to travel back and forth when interacting with the inset. Operations with the LensMouse viewport can be performed by touching the mouse screen, eliminating the need to move the cursor from the user's main display as in FIG. 1. Typical overview: operations such as panning a view finder can be easily carried out by tapping on the desired location within the LensMouse display using the index figure. The overview map on a popular strategy game, Warcraft 3 (w.blizzard.com/war3)www, was posted onto the LensMouse. With the index finger users can tap anywhere on the overview to refresh the display with a view of the desired location. Rapid movement around the map, as provided here is crucial for success in real-time strategy games.

Minimizing Window Management.

Many applications such as graphics editors are often crowded with inset windows hosting various widgets such as color palettes, toolbars, and layer dialogs. These inset windows are usually placed along the edges and are often made small or semi-transparent to facilitate viewing the main workspace. However, when the inset windows block necessary data, they need to be closed or relocated. The extra overhead managing these windows can be minimized with the LensMouse. Dialog windows were implemented from the Paint.NET graphics editor (www.paintnet.com) for the LensMouse as shown in FIG. 2. The LensMouse shows one inset window at a time. To replace it with another users can tap on the lens-bar. The user can then interact with the dialog box using their index finger, thereby reducing mouse trips on the main screen to control the properties in the dialog box.

Reducing Occlusion.

A common strategy for reducing occlusion is to place inset windows away from the region of interest, i.e. at the corners. However, this does not work when the insets pop-up in context-specific positions. For instance, translation applications, i.e. Powerword (http://ir.kingsoft.com)) provide a pop-up to show the translated word when the cursor hovers on the link. This window requires only temporary attention (and sometimes it is opened accidentally), but occludes in information behind the pop-up. A web-link preview lens was implemented that can show the contents of a web-link on the LensMouse when a user hovers over the link. By separating the unexpected pop-up insets from the main display, unnecessary distractions and occlusions are reduced. Subtle sounds also help notify the user that free information is on the mouse.

Numerous applications were also implemented, other than inset windows, that can benefit from the LensMouse. Most applications use a dedicated ‘lens’ for a specific task.

Nested Windows.

Manually searching for a file in nested folders is a routine task that can frustrate users as they drill or click into and out of the file structure to see the hidden information. A see-through lens was implemented as shown in FIG. 8(b) that allows users to quickly inspect the contents of a directory on the LensMouse before opening it. This is achieved simply hovering the cursor on the folder.

Overlapping Windows.

A see-over lens was implemented to allow users to see “behind” overlapping windows. It displays the overlapped region tough a virtual ‘hole’ around the cursor. To deal with multiple overlapped windows, the see-over lens always focuses on the very top overlapped window. The user can tap the mouse screen to bring the active window to the front of the main display.

Selecting Tiny Targets.

A magnifying lens as shown in FIG. 9 assists in selecting small targets (i.e. pixel-size objects) by amplifying them on the mouse. A small region under the cursor of the mouse is magnified and shown at a larger scale in the LensMouse. Objects visible in the lens can be directly manipulated with finger gestures.

Multi-point Interaction.

With the provision of two input controls (cursor and touch), the system can effectively recognize multiple points on the desktop. Multi-point interactions can be useful for common spatial tasks such as rotating and zooming. To rotate, the user places the cursor upon the object to be spun, then makes a circular finger motion on the mouse screen. Similarly, users can zoom into a specific location by pointing the cursor in that region and sliding the finger on a soft zoom control.

Private Notification.

Notifications of incoming emails or messages are sometimes distracting, especially when a system is connected to a public display (i.e. during a presentation). By setting the LensMouse into private mode, messages that would normally appear on-screen will be diverted to the private mouse display. Users can use simple, pre-configured gestures on the mouse screen to make quick responses, such as “be right back” [6].

Custom Controller.

The LensMouse can support numerous types of custom controls including soft buttons, sliders, pads, etc. For example, for a drawing application, access was provided to a color palette, for browsing long documents a multi-speed scroll-bar was implemented and to navigate web pages, front and back buttons were provided. As a custom controller, the LensMouse can provide any number of controls that can fit on the display for a given application, such as with the iPhone-AirMouse (airmouse.com).

### User Evaluation

Off-screen Target Selection.

Performance with LensMouse could be affected by frequent eye trips between the main screen and the mouse display. A first experiment was carried out to evaluate the degree to which separating the display affects user performance. Six computer science students volunteered for this experiment. The task required that participants select 9 off-screen objects using an overview+detail technique. The entire workspace was divided into a 3×3 grid: each of the 9 objects was placed into a cell on the grid. The size of each cell corresponded to the resolution of the 17″ LCD monitor used in the study. In the control condition (no LensMouse) the overview was placed at the bottom-right corner of the main screen. The participants double clicked or tapped (with the LensMouse) on the overview to navigate to an off-screen cell and then clicked on the target. In the control condition, the targets could end up being occluded by the overview thus the overview needed to be relocated before the participants attempted a selection. To start a block of trials, the participants clicked the start button in the center of the screen. The object to be selected was then highlighted in the overview. The objects were selected randomly. A block terminated after completing the selection of 9 objects. The participants were asked to complete 3 blocks with the LensMouse and 6 blocks (3 far occluded targets and 3 for unoccluded targets) with a regular mouse and overview. The order in which the conditions were presented was counter-balanced. The average time to complete the selection of each of the 9 targets was recorded.

Real-time Strategy Game.

The LensMouse prototype was also tested with Warcraft 3 a popular real-time strategy (RTS) game. Three computer science students, all with at least 50 hours of gaming time with Warcraft 3, were invited to play the game using the LensMouse for forty-five minutes. With the LensMouse the ability to navigate around the game map using the overview was implemented. The goal was to get preliminary user feedback.

Off-screen Target Selection.

A univariate ANOVA reveals that average performance with. LensMouse (2620 ms, s.e. 42.95) is similar to that with a regular mouse (2587 ms, s.e. 64.44; F(1,5)=0.01, p=0.92) when users were not required to relocate the virtual inset overview (unoccluded targets). This result suggests that eye trips, do not impose a negative impact on performance with the LensMouse. However, in trials requiring relocating the inset window, on average the LensMouse outperformed the regular mouse (3744 ms, s.e. 59.99; F(1,5)=9.9, p=0.02). Therefore in cases wherein the user requires managing the virtual inset window with a mouse, the LensMouse reveals significant improvements. Overall, the participants finished the task on average slightly; faster using the LensMouse (2620 ms, s.e. 50.65) than using the regular mouse (3232 ms, s.e. 50.65). Although this result is not significant (F(1,5)=3.55, p=0.12), it clearly shows the promise of the LensMouse.

Real-time Strategy Game.

User feedback from users playing the game with the LensMouse support our findings discussed above. Players were able to navigate easily around the game map and found the LensMouse ‘exciting”. Participants reported that if they were provided with such a device, they would use it and foresaw an advantage over opponents without it. They also required a brief period to become comfortable with the LensMouse and get familiar to having a display on the mouse. Upon completing the game, participants offered useful suggestions such as including hotkeys to trigger in-game commands or commands to rapidly view the overall status of the game. These can be easily implemented in our LensMouse prototype.

### LIMITATIONS

Ergonomics.

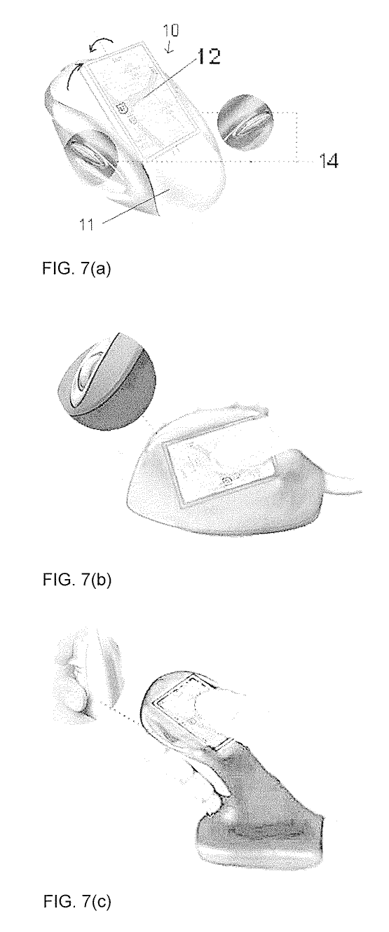

Our prototype demonstrates the essential features of LensMouse, but lacks certain ergonomic details. Presently, the display could be partly covered by the palm, requiring users to occasionally move their hand to the side of the mouse. However, this limitation can be easily alleviated by placing the display in a comfortable viewing position (using a tilt-able base) with left and right mouse buttons on either side of the mouse as shown in FIG. 7(a).

Touch Resolution.

Touch affords a lower quality resolution than a cursor. However, many of the tasks on the LensMouse do not require pixel-size manipulations. Using the finger for general purpose interactions can be further re-fined with the cursor.

Display Size.

The size of the display on the LensMouse is fixed. This could limit the number of controls that can be placed on this device and possibly make it difficult for applications requiring larger inset windows. However, as display resolutions improve, images can be streamed to be displayed on the LensMouse., by making them minimally sufficient for a given task.

As described herein LensMouse is a novel tangible device that serves as an additional viewport for inspecting objects on the desktop. The utility of the LensMouse was demonstrated through various applications. A preliminary user study reveals that the LensMouse is a welcome addition to the suite of incarnations witnessed by the mouse. Since the LensMouse can divide the user's attention from the main screen to the display on the peripheral device, it is best used for applications that requite a temporary view. Results of our study show that the peripheral LensMouse display can be more effective than inset windows on the desktop when the latter occlude objects. The LensMouse also serves the purpose of providing dynamic controls for various usage contexts. Future work will focus on reducing the overhead caused by dividing attention, by improving both the hardware design (especially the ergonomic properties of the mouse), as well as in carrying out several studies to evaluate the effectiveness of this novel device.

Referring to the accompanying figures there is illustrated an input and output peripheral device generally indicated by reference numeral 10. The device is suited for use with a personal computer of the type generally comprising a processor which receives input from various input devices including keyboards and the like and which sends outputs to various output devices such as a primary display screen, a printer, or speakers and the like.

In the preferred embodiment, the peripheral device 10 comprises an external device having its own housing 11 which is external of the housing of the computer for connection thereto by a suitable USB cable connection in communication with a USB port of the computer. As shown in FIG. 1, the housing 11 of the peripheral device 10 generally comprises a flat bottom side arranged to be engaged upon a horizontal supporting surface, for example a table top, for relative sliding movement. The bottom side incorporates a track mechanism of the type commonly used in a computer mouse for tracking a user initiated movement of the housing of the peripheral device relative to the supporting surface upon which it is engaged and for translating the movement into a corresponding first input signal which commonly corresponds to movement of a cursor of the computer across the primary display screen of the computer. The direction of movement and corresponding distance of movement are thus proportionally translated into a corresponding direction and distance of movement of the cursor. In further embodiments other tracking mechanisms known to be interchangeable with a computer mouse for controlling a cursor may also be incorporated into the peripheral device 10.

The housing of the peripheral device further comprises an output screen 12 supported integrally on the housing together with the tracking mechanism for movement together therewith relative to the supporting surface and the computer. The output screen is arranged to display an image thereon responsive to a peripheral output signal from the computer. The image may correspond to various objects being displayed according to the selected function of the device. The screen is typically angled upwardly and away from a front end of the housing which is arranged to be positioned nearest to the user so as to be received within the palm of the user when the user grips the device in a manner similar to a computer mouse. The screen may be pivotally mounted relative to the base to adjust the inclination thereof.

The sides of the housing extending alongside the screen 12 are ergonomically formed for supporting the thumb and fingers of the user thereon when the front end of the device is received within the palm of the user's hand. Buttons 14 may be incorporated into the sides of the housing for engagement by the fingers of the user for generating suitable left click and right click signals to be input into the computer in a manner similar to a conventional computer mouse. When providing buttons on the sides of the housing, the buttons are preferably offset laterally outward in relation to the screen so that the user's fingers do not obstruct the user's view of the screen when the fingers are in proximity to the buttons of the peripheral device.

The output screen includes a suitable touch responsive mechanism spanning the surface area of the screen such that user contact with any of the surface area of the screen can be readily determined by the touch responsive mechanism to generate a corresponding second input signal to the computer. The touch responsive mechanism may span the entire surface area of the display screen together with at least one auxiliary area surrounding the screen for generating various forms of inputs.

Typically a lower portion of the output screen nearest the user comprises a function selection area which is arranged to modify the function of the device by toggling between multiple different functions with each contact of the user with the function selection area. Whenever a new function is selected, the device modifies the image being displayed on the output screen to correspond to the new function and the corresponding function of the second input signal generated by the device to be input into the computer varies according to the new function of the device being selected.

In addition to or in place of the buttons along the sides of the housing, the touch responsive mechanism may also include a button area about the perimeter of the area of the output screen displaying an image thereon in which the images of a left click button and a right click button can be displayed for generating suitable second input signals in the form of a left click input signal and a right click signal responsive to user contact with the respective areas.

The touch responsive mechanism may further comprise a scroll area in which an image of a scrolling function is displayed and the touch responsive mechanism is arranged to translate a user movement of a finger being dragged across the scroll area into a proportional scrolling input signal which results in a scrolling function on the computer.

In yet further arrangements the device may be arranged to generate a computer click input signal by providing the touch responsive mechanism with a prescribed pressure threshold. In this instance user contact with the output screen which exceeds the prescribed pressure threshold results in the computer click input signal being generated instead of the usual function of selecting an area on the image.

Typical uses for the peripheral device 10 include displaying various information to the user which would otherwise occupy desirable real estate on the surface area of the primary output screen of the computer. When used with a computer comprising a windows type graphical user interface in which different windows are used to graphically represent different applications or different folders on the primary display screen of the computer, the output screen of the peripheral device can be arranged to display an auxiliary output of the windows user interface so that the auxiliary output information is not required to be displayed on the primary display screen. In addition to maximizing use of the primary display screen, the output screen of the peripheral device enhances privacy for the user as various forms of information can be communicated to the user in a more discrete fashion using the smaller screen of the peripheral device instead of the larger screen which is more visible to others, and in some instances is used for presentations or demonstrations and the like.

In some instances therefore the peripheral device includes a suitable interface, for example a plug in for an application, or a suitable driver which is run on the computer to alter the normal function of the computer and re-route private information to be displayed only on the output screen of the peripheral device and not on the primary display of the computer. The peripheral device typically includes a notification system arranged to notify a user when new information is displayed or refreshed on the output screen of the peripheral device. This is most useful when the information is displayed in a private manner such that the information is not visible on the primary display of the computer. In this instance the notification may comprise an audible notification by a speaker on the peripheral device or a vibrating notification by a suitable vibrating module incorporated into the housing of the peripheral device.

As described above, the various functions of the output screen and the second input signal generated by the touch responsive mechanism associated with the output screen vary depending upon the different applications being run on the computer. Typically the auxiliary output from a windows user interface on the computer is in the form of an auxiliary window which may comprise an inset window normally displayed in a corner of the primary display screen.

In some applications the inset window may comprise a tool bar including various types of editing or graphic tools and the like for controlling various editing functions in various applications. Pop up message windows and various types of pop up messages normally appearing in the bottom corner of the primary display screen can also be redirected by the peripheral device to the output screen thereof. In some instances the window being displayed may comprise some form of dialogue box or other interactive notification to which the user can respond or interact by user contact with the touch responsive mechanism associated with the output screen independent of the control of the cursor by the tracking mechanism of the peripheral device. More particularly the tracking mechanism which determines the location of the cursor maintains the cursor in a fixed location where the movement of the peripheral device is not required to interact with the touch responsive mechanism. The independent ability to generate a second input signal at a selected location based on user contact at a corresponding location on the output screen of the peripheral device eliminates the need for users to relocate the cursor on a primary display screen to an auxiliary output window in a corner of the screen and instead maintains the cursor in an active area of the primary display screen. Although in some instances the second input signal can be generated independently of the location of the cursor such that the location of the cursor is not effected by the second input signal, in other instances the output screen may instead by used to rapidly relocate the cursor to a different location relative to the primary output screen.

According to further uses of the peripheral device, the second input signal generated by the touch responsive mechanism of the output screen of the peripheral device provides a further degree of navigation control through a plurality of nested windows in a windows user interface of the computer. When the windows represent folders with a plurality of layers nested within one another, locating the cursor in proximity to one of the nested windows can be used to select one of the windows to be previewed in a preview mode of operation of the peripheral device. In this instance the contents of the nested window are displayed on the output screen of the peripheral device while the appearance of the primary display screen remains unchanged so that the user does not actually require selecting a folder to view the contents thereof as would normally occur when the input device of the computer comprises a conventional mouse.

In a similar manner, the cursor can be used to hover over a web link displayed on the primary display screen of the computer with the output screen of the peripheral device being configured to display a preview of the contents of the web link without actually navigating the primary display screen to the destination of the web link.

According to a further function, when numerous applications or folders are open at a given time on a windows user interface of the computer such that a plurality of windows resultingly overlap one another, typically one of the windows comprises an active primary window while the remaining windows comprise inactive windows overlapped by the active primary window. In this instance locating the cursor on the primary display screen results in an area of the primary display screen in proximity to the cursor to be represented on the output screen of the peripheral device, but with the active primary window being shown transparently so that an uppermost one of the plurality of inactive windows overlapped by the active window is effectively represented on the output screen of the peripheral device.

The auxiliary output window displayed by the output screen of the peripheral device may yet further comprise a magnified portion of the primary display screen corresponding to a cursor location determined by the tracking mechanism in accordance with a further function of the device.

Some of the functions of the output screen of the peripheral device can rely on existing information which is streamed from the computer or an active application of the computer so that minimal additional software is required to operate the peripheral device. In further instances however, certain programs are modified from their normal operation by a suitable plug in, or alternatively suitable driver software is provided to provide a new stream of auxiliary information from the computer or an active application of the computer to display the auxiliary information on the output screen to considerably enhance the functionality of the computer. One example of modifying the normal operation of the computer is to redirect notifications normally appearing on the primary display screen to the output screen to maintain privacy on the primary display screen of the computer.

When using the peripheral device to manipulate an object on the primary display screen, for example changing the size of an object by zooming in and out, moving an object across the screen, or rotating the object relative to the desktop environment on the screen, one of the aspects can be controlled by displacement of the tracking mechanism so that the first input signal manipulates the first aspect of the selected object while the touch responsive mechanism and the second input signal generated thereby can be used to manipulate an independent second aspect of the selected object.

A user in this instance can simultaneously and independently manipulate two different aspects of a selected object by both displacing the housing of the peripheral device relative to the supporting surface to activate the tracking mechanism while also varying the user contact across the touch responsive mechanism of the output screen. Typically the second input signal generated by the touch responsive mechanism is arranged to be proportional to the contact of the user and the movement of the user contact across the output screen. Accordingly a longer movement of the user contact across the screen results in a correspondingly longer second input signal being generated, while the direction of the user movement across the output screen can also correspond to a directional second input signal to be input into the computer.

In one example, the surface area of the touch responsive mechanism associated with the output screen of the peripheral device is arranged to be sub-divided into a plurality of different designated areas arranged to generate different respective second input signals. In this instance the proportional second input signal being generated by the different areas may vary in rate or degree of proportion relative to one another. When used for scrolling, one designated area may comprise a slow scrolling function while the other designated area comprises a fast scrolling function. In this instance an identical user contact and movement across the two different designated areas results in a different length or speed of scrolling to be effected by the corresponding second input signals being generated. In other instances, different areas of the touch responsive mechanism on the output screen may similarly result in different characteristics of the second input signals being generated. In typical embodiments the function of the second input signal will vary according to the active application being executed by the computer.

The peripheral device 10 according to the present invention is referred to herein as LensMouse. As describe above, the display acts as a tangible and multi-purpose auxiliary window—or lens—through which users can view additional information without consuming screen real-estate on the user's monitor. Equally important is the provision of direct-touch input on the LensMouse display. With a touch of a finger, users can directly interact with content on the auxiliary display.

LensMouse allows users to interact with and view auxiliary digital content without needing to use a dedicated input device, or indeed change their hand posture significantly. A variety of uses for such a novel device are described herein, including viewing and interacting with toolbars and palettes for an application or game, previewing web pages and folder contents, interacting with magnified primary screen content, pop-up dialog boxes, and performing touch gestures.

Perhaps one of the main strengths of LensMouse is in dealing with auxiliary windows, such as instant notifications, color palettes, or navigation tools that occupy regions of the primary screen. Whilst necessary for the user's task, they can consume precious real-estate and occlude parts of the user's primary workspace. This can result in additional window management overhead to move or close the auxiliary window. Additionally, users have to divert their mouse cursor from their workspace over to the auxiliary window to interact with it. This task can be time consuming particularly when the user's display is large. Pop-up auxiliary windows can occasionally distract users, particularly when they are not immediately of use, such as with notifications from other applications on the desktop.

LensMouse can be used to ‘free up’ these auxiliary windows from the primary screen, allowing them to be viewed and interacted with readily on a dedicated screen that is always within easy reach of the user. A controlled experiment has been conducted that demonstrates the utility of LensMouse in dealing with the issues of auxiliary windows. The study demonstrates that users can interact and view the auxiliary display without extra cognitive or motor load; and can readily interact with on-screen content without significant mouse movements.

The present invention as described herein presents: 1) a novel input device prototype augmented with an interactive touch display; 2) a solution to overcome challenges with auxiliary windows; 3) a demonstration of some of the benefits of our device through a user experiment; and 4) a set of applications and interactions that can benefit from such a device.

Adding a touch-enabled display onto a mouse follows a long-standing research trend in augmenting mice with powerful and diverse features. Many augmentations have been successful such as the scroll-wheel which is now indispensable for many tasks on today's desktops [20]. Other augmentations include extending the degrees-of-freedom of the mouse [6, 19], adding pressure input [9, 35], providing multi-touch input [39], supporting bi-manual interactions [6, 25], and extending the controls on a mice to a secondary device [25]. Our research prototype complements and extends this existing literature by considering a rich set of both output and input functionalities on top of regular mouse-based input.

On one level, LensMouse can be considered as a small movable secondary display. There has been a great deal of research on the use of and interactions with multiple desktop monitors. Some of this research is highlighted, as it is relevant to the present invention.

Multi-display vs. Single Display Interactions

While a decade ago most computers were controlled with a single monitor, today dual-monitor setups are common, and are leading to novel multi-display systems [10, 21]. An additional monitor provides the user with more screen real estate. However, users seldom extend a window across two monitors. Instead, they distribute different tasks among monitors [12]. With more screen space available, the increased amount of mouse trips among displays becomes an issue. Therefore, users tend to put tasks involving frequent interactions on the primary monitor, while tasks that require fewer interactions, such as checking email updates, are delegated to the second monitor [12, 14]. A quantitative result by Bi et al. [7] confirmed that 71% of all mouse events in a dual-monitor setup occur on the primary display.

The primary benefits of a secondary display include allowing users to view applications, such as document windows simultaneously or to monitor updates peripherally. For tasks involving frequent switching between applications, dual-monitor users are faster and have less workload than single-monitor users [24, 36]. The literature in multi-monitor systems also reveals that users like to separate the monitors by some distance instead of placing them in immediate proximity [12]. One may believe that this could lead to visual separation problems, where significant head movements are required to scan for content across both displays.

A study by Tan et al. [37] in which participants were asked to identify grammatical errors spread across two documents each on a different monitor, showed that distance between displays played a negligible role in task performance. They found only small effects of visual separation when the second display was placed far away from the main display. This result was also supported by an earlier study revealing that separating two monitors at a relatively long distance (the full width of one monitor) did not slow down users' access to information across both monitors [36]. These findings on the negligible effects of visual separation support the concept of having a separate auxiliary display, such as that on LensMouse, for dedicated information content. There is also the additional advantage of direct-touch interaction with the content on LensMouse.

Multi-monitor setups also present several drawbacks, the most significant being an increased amount of cursor movement across monitors resulting in workload overhead [34]. Alleviating this issue has been the focus of much research. Minimizing mouse trips across monitors There are many ways to support cross-display cursor movement. Stitching is a technique commonly used by operation systems (e.g. Windows™ and MacOS™). It warps the cursor from the edge of one display to the edge of the other. In contrast, Mouse Ether [4] offsets the cursor's landing position to eliminate wrapping effects introduced by Stitching. Although both methods are effective [29], users still need to make a substantial amount of cursor movements to acquire remote targets. Object cursor [13] addresses this issue by ignoring empty space between objects.

Delphian Desktop [2] predicts the destination of the cursor based on initial movement and rapidly ‘flies’ the cursor towards its target. Although these techniques were designed for single monitor conditions, they can be easily tailored for multi-monitor setups. Head and eye tracking techniques were proposed to position the cursor on the monitor of interest [1, 11]. This reduces significant mouse trips but at the cost of access to expensive tracking equipment. Benko et al. propose to manually issue a command (i.e. a button click) to ship the mouse pointer to a desired screen [3]. This results in bringing the mouse pointer close to the task but at the cost of mode switching. The Mudibo system [15] shows a copy of an interface such as a dialog box on every monitor, as a result it does not matter which monitor the mouse cursor resides on. Mudibo was found useful [16] but distributing redundant copies of information content across multiple monitors introduces problems such as distracting the user's attention and wasting screen estate. Ninja cursors [23] and its variants address this problem by presenting a mouse cursor on each monitor. This solution is elegantly simple but controlling multiple cursors with one mouse, adds an extra overhead of having to return the cursor to its original position on one monitor after using it for the other.

LensMouse Prototype

A LensMouse prototype was created by attaching a touch-enabled Smartphone (HTC touch) to the base of a USB mouse as represented in FIG. 1. The LensMouse display is tilted toward the user to improve viewing angle. The display hosts a number of soft buttons, including left and right buttons and a soft scroll-wheel. The remaining space on the display allows application designers to place auxiliary windows that would normally consume screen real-estate on a desktop monitor.

Different types of auxiliary windows, such as toolbars, palettes, pop-ups and other notification windows, can be migrated to the LensMouse display. Another class of auxiliary windows that can be supported on LensMouse are overview+detail (or focus+context) views [30, 41]. Here the small overview window can be displayed on the LensMouse to provide contextual information. For example, map-based applications can dedicate an overview window or a magnifying lens on the LensMouse. Overviews have proven to be useful for a variety of tasks [18, 31]. Auxiliary windows displayed on the LensMouse are referred to as ‘lenses’. LensMouse can incorporate several ‘lenses’ simultaneously. To switch between different lenses, a ‘lens-bar’ is displayed at the bottom of the display. Tapping on the lens-bar iterates through all the lenses. Finally, since the LensMouse display is separated from the user's view of the primary monitor, users are notified of important updates on LensMouse by subtle audio cues.

Key Benefits of LensMouse

LensMouse addresses some of the challenges present with auxiliary windows, multiple monitors and other related work as described in this section.

Reducing Mouse Trips

Auxiliary windows in particular palettes and toolbars often float in-front of or to the side of the main application window. This maximizes the display area for the main application window, but also leads to mouse travel back-and-forth between windows. Operations with the LensMouse display can be performed by directly touching the mouse screen, eliminating the need to move the cursor away from the user's main working area to these auxiliary windows. For example, selecting a new color in a paint palette or changing the brush width can be done by directly touching the LensMouse screen without needing to move the mouse away from the main canvas as shown in FIG. 2.

Minimizing Window Management

Many applications such as graphics editors are often crowded with small windows hosting various widgets such as palettes, toolbars, and other dialog boxes. When the windows occlude important content, they need to be closed or relocated. The extra overhead in managing these windows can be minimized with LensMouse. LensMouse shows one window at a time. To switch to another, users simply tap on the lens-bar. As a result, window management does not incur mouse trips and only the current window of interest is presented to the user at any given time.

Reducing Occlusion

Certain applications rely heavily on auxiliary windows to relay feedback or other information content to their users. Designers typically resort to various strategies when displaying these windows, since these are known to occlude the main workspace and thus distract users from their main tasks [5, 22]. In many cases, such as with notifications, these windows will pop-up unexpectedly, thus taking the users attention away from their tasks. With LensMouse, such pop-ups can be displayed on the display of the mouse and users could be alerted of their appearance through a notification. By separating the unexpected pop-up windows from the main display, unnecessary distractions and occlusions are reduced.

Minimizing Workspace “Distortions”

To improve task performance researchers have proposed a number of techniques that “distort” the user's visual workspace [26, 33]. For example, distorting target size, i.e. making it larger, can improve targeting performance [26]. This can be detrimental to the selection task if nearby targets are densely laid out [26]. Instead of “distorting” the visual workspace, with LensMouse the targets can be enlarged on the mouse display for easier selection with the finger, leaving the primary workspace unaffected. Other similar effects, such as fisheye distortions, can be avoided by leaving the workspace intact and simply producing the required effect on LensMouse. In a broad sense “distortions” could also include operations such as web browsing that involves following candidate links before finding the required item of interest. Instead, previews of web links can be displayed as thumbnail images on LensMouse, thus leaving the original web page as is. Other such examples include panning around maps to find items of interest, scrolling a document or zooming out of a workspace. Such display alterations can take place on LensMouse and thus leave the user's primary workspace intact. This has the benefit that users do not have to spend extra effort to revert the workspace to its original view.

### EXPERIMENT

It has been postulated that a primary benefit of LensMouse consists of reducing mouse trips by allowing the user to access contextual information with their fingertips. However, the potential drawbacks of having a display on LensMouse are also acknowledged, such as the visual separation from the primary display, smaller screen size, and occlusion by the users' hand. Prior studies on multiple monitor setups do not show a significant impact of visual separation on task performance [37, 16]. Such studies were carried out with regular-sized monitors in vertical setups, e.g. monitors stood in front of users. This leaves it unclear whether visual separation has a significant impact on performance with LensMouse, where a smaller display, which is more susceptible to hand occlusion, is used almost in a horizontal setup.

To unpack these issues, a study was conducted. A specific goal of this study was to evaluate whether users are more effective at carrying out tasks when part of the interface is relegated to LensMouse. LensMouse was evaluated against single-monitor and dual-monitor conditions. In all conditions, the monitor(s) were placed at a comfortable distance from participants. In the singlemonitor condition, the entire task was carried out on a single monitor. In the dual-monitor condition, the task was visually distributed across two monitors with each monitor slightly angled and facing the participants. The LensMouse condition was similar to the dual-monitor setup, except that the task was visually distributed across the main monitor and LensMouse display.

Materials

The display on LensMouse had a size of 1.6×2.2 inch, and ran at a resolution of 480×640. 22″ Samsung LCD monitors were used for both single and dual-monitor setups. Both monitors ran at a resolution of 1680×1050, and were adjusted to be roughly equivalent in brightness to the display on LensMouse. The study was implemented in Trolltech QT, and was run on a computer with 1.8 GHz processor and 3GB memory. A pilot study showed no difference between the mousing capabilities of LensMouse and a regular mouse in performing target selection tasks. Therefore, LensMouse was used for all conditions in place of a regular mouse to remove any potential confounds caused by the mouse parameters. In the non-LensMouse conditions, participants clicked on LensMouse soft buttons to perform selection.

Participants

Fourteen participants (10 males and 4 females) between the ages of 21 and 40 were recruited from a local university to participate in this study. Participants were daily computer users. All of our participants were right-handed users.

Task

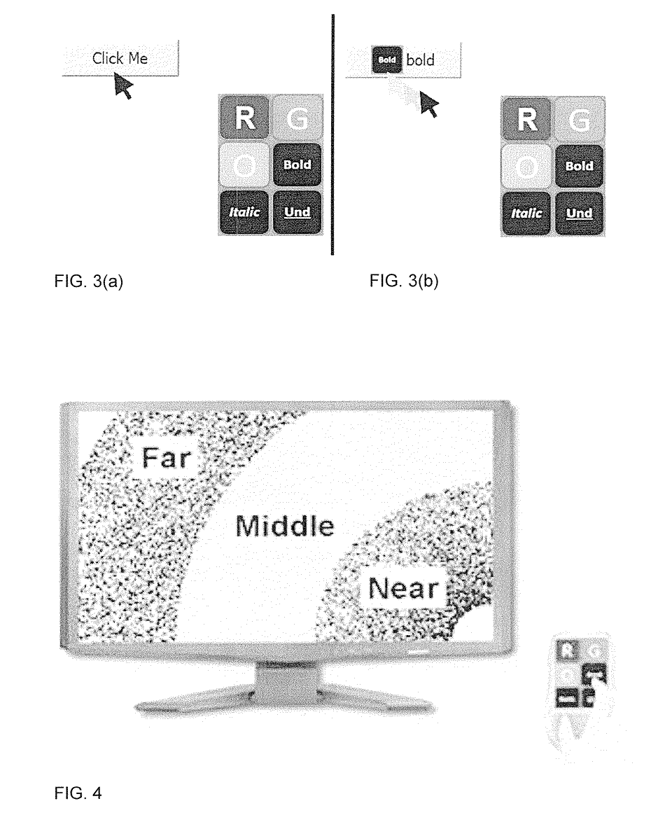

To evaluate the various influencing factors, a cross-window pointing task was designed for this experiment. This task is analogous to that employed by users of text or graphics editing programs and is comprised of two immediate steps. The first step requires participants to click a button on the main screen to invoke a text instruction as in FIG. 3(a). Following the instruction, participants performed the second step by clicking one of the tool buttons in a tool palette window, corresponding to that instruction as in FIG. 3(b). Cross-window pointing is representative of common object attribute editing tasks in which users must first select an object (by either highlighting or clicking it) and then visually searching for the desired action in an auxiliary window that hosts the available options. Examples of such a task include changing the font or color of selected text in Microsoft Word, or interacting with the color palettes in Adobe Photoshop.

At the beginning of the task, an instruction button was placed in a random location on the main screen. Participants move the mouse cursor to click the button to reveal a text instruction. The text instruction is chosen randomly from an instruction pool, such as Bold, Italic, Und, etc. Following the instruction, participants picked the matching tool icon by clicking or tapping directly (in the LensMouse condition) on the tool palette. Upon selection, the next instruction button showed up in a different location. This was repeated over multiple trials and conditions.

Design

The experiment employed a 4×2 within-subject factorial design. The independent variables were Display Type: Toolbox (TB), Dual-monitor (DM), Context Window (CW) and LensMouse (LM)); and Number of Icons: 6 icons and 12 icons.

Toolbox (TB)

The Toolbox condition simulated the most frequent case in which auxiliary windows are docked in a region on the main display. In most applications the user has control of placing the window but by default these appear toward the edges of the display. In the Toolbox condition, the tool palette was placed at the bottom-right corner of the screen, such that instruction buttons would always be visible.

Dual-monitor (DM)

In the dual-monitor condition, the tool palette was shown on a second monitor that was placed to the right of the main screen showing the instruction buttons. To determine the location of the tool palette, five dual-monitor users were observed in a research lab at a local university, and found that most of them placed small application windows, such as instant messaging or media player windows, at the center of the second monitor for easy and rapid access. Tan et al's [37] study found no significant effect of document location on the second monitor. Based on these two factors, the tool palette was placed at the center of the second screen.

Context Window (CW)

Certain modern applications, such as Microsoft Word 2007, invoke a contextual pop-up palette or toolbar near the cursor when an item is selected. For example, in Word when text is highlighted, a semitransparent ‘text toolbar’ appears next to the text. Moving the mouse over the toolbar makes it fully opaque and interactive. Moving the cursor away from the toolbar causes it to fade out gradually until it disappears and is no longer available. A Context Window condition was created to simulate such an interaction. Once the user clicked on an instruction the tool palette appeared below the mouse cursor and disappeared when the selection was completed. Fade-in/fade-out transitions were not used as this would impact performance times. The physical size of the palette was also maintained to be the same as in all other conditions.

LensMouse (LM)

In the LensMouse condition, the tool palette was shown using the full display area of the mouse. Unlike the other three conditions, participants made selections on the palette using a direct-touch finger tap gesture. On the LensMouse palettes of different sizes can be created. The literature suggests that for touch input icons less than 9 mm can degrade performance [32, 40]. Based on the size of our display, palettes containing up to 18 icons on the LensMouse can be created. This study was restricted to palettes of 6 and 12 icons, as these numbers would be the practical limits on what users could expect to have on a toolbar. The physical size of tool palette remained constant across all displays conditions (monitors and LensMouse). In the cross-window pointing task, after the users first click on the instruction button using the soft button on LensMouse, the rest of the display is partially occluded by the palm. This was deliberately planned as it resembles many real world scenarios in which the LensMouse display could indeed be occluded by the palm. The Number of Icons was selected in a grid arrangement consisting of 2×3 or 3×4 icons (6 and 12 icons respectively). With 6 icons the targets were 20.5×18.7 mm and with 12 icons the targets were 13.7×14 mm.

In each trial, participants performed tasks in one of each Display Type×Number of Icons combination. The experiment consisted of 8 blocks, each consisting of 18 trials. The Display Type factor was partially counter balanced among participants. The experimental design can be summarized as: 4 Display Types×2 Number of Icons×8 Blocks×18 Repetitions×14 Participants=16128 data points in total. Dependent measures included the number of errors and the average task completion time. Task completion time was recorded as the time elapsed from a click on the instruction button to a click on the corresponding icon on the tool palette. An incorrect selection occurred when the participant clicked on the wrong icon in the palette.

Procedure

At the start of each trial, an instruction button was placed randomly in one of three predefined regions identified by the distance to the bottom-right corner of the display where the Toolbox is placed, and also near where LensMouse is likely to be placed, as shown in FIG. 4. The three distances were selected such that the instruction item could be either close or far away from LensMouse. The items in the Near region were between 168˜728 pixels away from the bottom-right corner; the Middle region 728˜1288 pixels; and the Far region 1288˜1848 pixels. This would allow us to test the impact of visual separation if it was present.

Prior to starting the experiment, participants were shown the LensMouse prototype and its features, and were also allowed several practice trials in each condition. Participants were asked to finish the task as fast and as accurately as possible. A break of 15 seconds was enforced at the end of each block of trials. The entire experiment lasted slightly under 60 minutes. Participants filled out a post-experiment questionnaire upon completion.

Results and Discussion

The collected data was analyzed using a repeated measure ANOVA test and Tamhane post-hoc pair-wise tests.

Task Completion Time

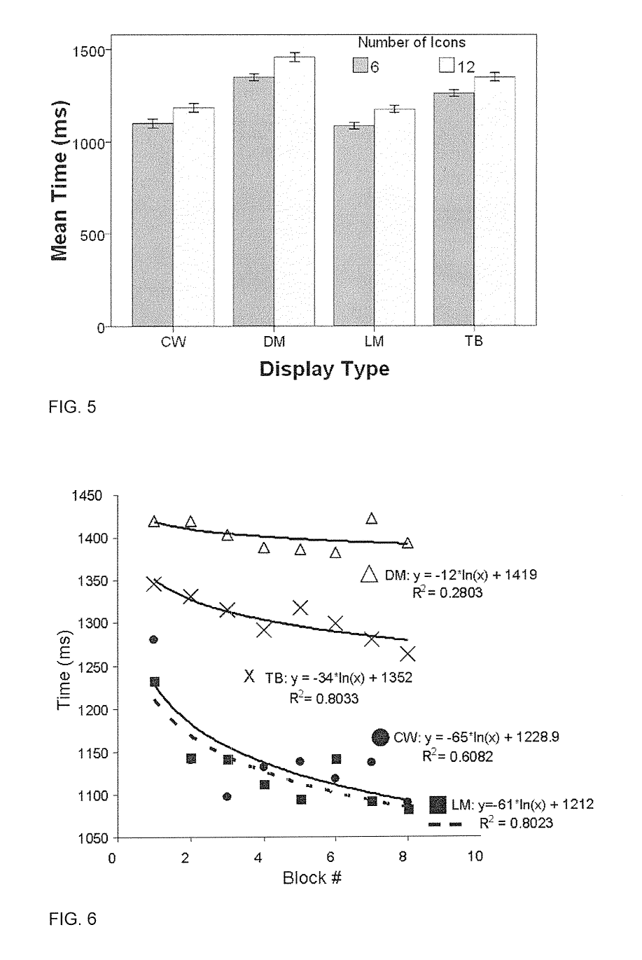

Task completion time was defined as the time taken to make a selection in the tool palette after an instruction button was clicked. Our analysis of completion time does not include trials in which an error was made during the tool selection. The overall average completion time was 1245 ms. ANOVA yielded a significant effect of Display Type (F3,39=50.87, p<0.001) and Number of Icons (F1,13=10.572, p<0.01). FIG. 5 shows average completion time for each Display Type by Number of Icons. No interaction effects were found on Display Type×Number of Icons (F3,39=0.262, p=0.852).

Performance with LensMouse (1132 ms, s.e. 6.5 ms) was significantly faster than with the Dual-monitor (1403 ms, s.e. 6.4 ms) and the Toolbox (1307 ms, s.e. 6.5 ms) conditions. Interestingly, post-hoc pair-wise comparisons showed no significant difference between the Context Window (1141 ms, s.e. 6.4 ms) and LensMouse (p=0.917). As expected, it took participants longer to select from the palette of size 12 (1292 ms, s.e. 4.6 ms) than from the palette of size 6 (1200 ms, s.e. 4.6 ms). This is not surprising considering that icons were smaller on the palette of 12 items.

As expected, techniques requiring significant mouse trips, such as the Dual-monitor and Toolbox, took users longer to finish the task. This is consistent with our understanding of targeting performance based on Fitts' Law [28]. LensMouse performed as fast as the Context Window. This clearly shows that even though LensMouse may be affected by visual separation, this was compensated by the advantage of minimizing mouse trips, and resulted in a net gain compared to the Toolbox and Dual-monitor setups.

Number of Errors

Errors were recorded when participants made a wrong selection in the palette. The overall average error rate was 1.4%. Analysis showed no main effect of Display Type (F3,39=1.708, p=0.181) or Number of Icons (F1,13=0.069, p=0.797) on error rate. Neither were any interaction effects found for Display Type×Number of Icons (F3,39=1.466, p=0.239). All techniques scored error rates that were lower than 2%. Even though not statistically significant, LensMouse exhibited more errors (1.7%, s.e. 0.02) than the other conditions. This was followed by the Dualmonitor (1.5%, s.e. 0.02), Context Window (1.2%, s.e. 0.02), and Toolbox (1.2% s.e. 0.02). The error rate on LensMouse was largely a result of imprecise selection with fingertips, a known problem for touch displays [40], which could be alleviated in both hardware and software.

Learning Effects

The learning effects captured by participant performance for each of the display types were analyzed. There was a significant main effect on task completion for Block (F7,91=6.006, p<0.01) but there was no significant interaction effect for Block×Display Type (F21,273=1.258, p=0.204) or for Block×Number of Icons (F7,91=0.411, p=0.893). As can be seen in FIG. 6 there is a steeper learning curve for LensMouse and Context Window techniques. Post-hoc analyses showed that with LensMouse, significant skill improvement happened between the first and the third block (p<0.001). But there was no significant learning after the third block (all p>0.31). Interestingly, a similar learning pattern was found with the Context Window technique. On the other hand, task completion time decreased almost linearly with the Dual-monitor and Toolbox techniques. No significant skill improvements were observed (all p>0.75).

Although the results of LensMouse and Context Window are similar, the learning effects between all techniques were slightly different. The learning effects taking place in the Context Window condition were in part due to getting familiar with different button/icon locations to reduce visual search time. However, learning effects with LensMouse were mainly due to the process of developing motor memory skills through finger selection. This was apparent in our qualitative observations—participants were no longer looking at LensMouse display after the 4th or 5th block of trials.

Effects of Visual Separation

Our experimental design accounted for visual separation effects that would possibly be present with LensMouse. The analysis was performed by looking at targeting performance when targets were in one of the three regions Near, Middle, and Far. There was no main effect of performance time for visual separation with LensMouse (F2,26=1.883, p=0.172). Nor was any main effect of visual separation found on number of errors (F2,26=3.322, p=0.052). Even though not statistically significant, LensMouse exhibited more errors in the Middle (2.2%, s.e. 0.04) and Far (1.9%, s.e. 0.04) region than in the Near region (1%, s.e. 0.04).

Subjective Preference

The post-experiment questionnaire filled out by all the participants show that the users welcomed the unique features provided by LensMouse. They also indicated a high level of interest in using such a device if it were made commercially available. All scores reported below are based on a 5-point Likert scale, with 5 indicating highest preference. The participants gave an average of 4 (5 is most preferred) to LensMouse and Context Window as the two most preferred display types. These ratings were significantly higher than the ratings for Toolbox (avg. 3) and Dual-monitor (avg. 2). It was noticed that more people rated LensMouse at 5 (50%) than the Context Window (36%). The same trend in average scores were obtained (LensMouse: 4, Context Window: 4, Toolbox: 3, and Dual-monitor: 2) in response to the question: “how do you perceive the speed of each technique?” This is consistent with our quantitative results described in the previous section. Additionally, participants found LensMouse to be easy to use (3.9, 5 is easiest). The score was just slightly lower than the Context Window (4.3) but still higher than the Toolbox (3.1) and the Dual-monitor (2.7). Finally, the participants gave LensMouse and Context Window an average of 4 (5 is most control) in response to “rate each technique for the amount of control available with each”. The rating was significantly higher than the rating of Toolbox (3) and Dual-monitor (3). Overall, 85% of all our participants expressed the desire to use LensMouse if it was available on the market. In addition, 92% of the participants felt that the display on LensMouse would help them with certain tasks they performed in their work, such as rapid icon selection. Finally, 70% of the participants saw themselves using LensMouse when doing tasks in applications such as MS Word, Power-Point, or even browsing the Internet. It is worth noting that the current LensMouse is just a prototype, and could be significantly improved in terms of ergonomically.

Preliminary Qualitative Evaluation with a Strategy Game

In addition to the quantitative experiment, a qualitatively test of the LensMouse prototype has also been conducted with Warcraft 3, a real-time strategy game. Whilst by no means a full study, this study was used to distil preliminary user feedback of using LensMouse with a popular commercial software product. Three computer science students, all with at least 50 hours of experience playing Warcraft 3, were invited to play the game using LensMouse for forty-five minutes. With LensMouse the ability to navigate around the game map was implemented using the overview. Users could simply tap on the overview with LensMouse to navigate the overall game map. This has the effect of reducing mouse movement between the main workspace and the overview window. Users required a brief period to get familiar with LensMouse and to having a display on top of a mouse. User feedback supported our findings discussed earlier. Players were able to navigate easily around the game map and found LensMouse “exciting”. The garners immediately saw an advantage over their opponents without it. Upon completing the game, participants offered useful suggestions such as including hotkeys to trigger in-game commands or to rapidly view the overall status of the game. Such features can be easily implemented in our prototype and would give players who have access to LensMouse a significant advantage over those without the device.

This study shows that users can perform routine selection operation tasks faster using LensMouse than using a typical toolbox or dual-display setup. The performance of LensMouse is similar to the performance of the context window, a popular technique for facilitating the reduction of mouse travel. However, the context window has several limitations making it less suitable in many scenarios. First, the context window is transient and needs to be implicitly triggered by the user through selection of some content, thus making it unsuitable for hosting auxiliary windows that need frequent interaction. Second, a context window may occlude surrounding objects, causing the user to lose some of the information in the main workspace. For this reason, context windows in current commercial systems such as MS Word are often designed to be small and only contain the most frequently used options. In comparison, LensMouse provides a persistent display with a reasonably large size, thus minimizing these limitations, and with the added benefit of direct-touch input and rapid access. Prior to our study it was speculated that the practical benefits of LensMouse would be severely challenged by visual separation. Our results reveal that the minimal (almost negligible) effect of visual separation is compensated by the advantages of direct touch on the LensMouse, and results in a positive net gain in performance.

Additionally, the benefits of direct touch also outweigh the potential cost of occluding the LensMouse display with the palm of the hand. Note that in our task users were first required to click on the instruction button using the left mouse button. This would result in partially occluding the LensMouse display and consequently the palette. Despite this concern, hand occlusion did not affect overall performance, nor did users report any frustration from this effect. It is also worth noting that our prototype demonstrates the essential features of LensMouse, but is ergonomically far from perfect. Presently, the display could become partially covered by the palm, requiring users to occasionally move their hand to one side. However, this limitation can be easily alleviated through better ergonomic design. One possible solution is to place the display in a comfortable viewing position (using a tiltable base) with left and right mouse buttons placed on either side of the mouse as shown in FIG. 7(a). Another solution is to place the display and the buttons on different facets of the mouse as shown in FIG. 7 (b). Such a configuration would allow users to operate LensMouse like a normal mouse, while still keeping users' fingers close to its display. Multi-touch input [39] could be performed easily using thumb and index finger. Furthermore, a joystick-shape LensMouse as shown in FIG. 7(c) could allow users to operate the touch screen using the thumb. Direct touch input on the LensMouse affords a lower resolution than that with relative cursor control. However, many of the tasks on LensMouse do not require pixel-level operations.

When such operation were required, techniques such as Shift [40] could be employed to alleviate the fat-finger problem, Finally, the size of the display on LensMouse is relatively small. This could limit the number of controls that can be placed on this device and possibly make it difficult for applications requiring larger windows. However, supporting panning operation on LensMouse could be considered by using finger gestures to accommodate more content.

Beyond Auxiliary Windows

In addition to resolving some of the challenges with auxiliary windows, LensMouse may serve many other purposes:

Custom Screen ‘Shortcut’

In addition to migrating predefined auxiliary windows to LensMouse, the user may take a ‘snapshot’ of any rectangular region of the primary screen, and create a local copy of the region on LensMouse, as in WinCuts [38]. Any finger input on LensMouse is then piped back to that screen region. By doing so, the user can create a custom ‘shortcut’ to any portion of the screen, and benefit from efficient access and direct input similar to that shown in our experiment.

Preview Lens

LensMouse can also serve as a means to preview content associated with a UI object without committing a selection. FIG. 8a shows a how such a preview lens can be used to reveal the folder's content on the LensMouse by simply hovering over the folder icon. This could aid search tasks where multiple folders have to be traversed rapidly.

See-through Lens

Another use of the LensMouse is for seeing through screen objects [8], e.g. overlapping windows as shown in FIG. 8(b). Overlapping windows often result in window management overhead spent in switching between them. A see-through lens was implemented to allow users to see “behind” overlapping windows. In our current implementation, users have access only to content that is directly behind the active window. However, in future implementations the user will be able to flick their finger on the display and thus iterate through the stack of overlapping screens.

Hybrid Pointing

LensMouse integrates both direct-touch input and conventional mouse cursor pointing. This offers a unique style of hybrid pointing. In one demonstrator, a prototype was built that shows a magnifying lens that amplifies the region around the cursor as shown in FIG. 9(a). The user can move the LensMouse first to coarsely position the cursor near the target, then use the finger to select the magnified target on the LensMouse display. For farther away targets that are cumbersome to reach, LensMouse shows an overview of the whole workspace as shown in FIG. 9(b). By touching the finger on the overview, the user can directly land the cursor in the proximity of the target, and then refine the cursor position by moving LensMouse. By combining the absolute pointing of touch with the relative pointing of the mouse in different manners, there is the potential for new possibilities in selection and pointing.

Gestural Interaction

With the addition of touch input, the user can apply various finger gestures to interact with the object under the cursor such as rotating and zooming. To rotate, the user places the cursor upon the object to be spun, then makes a circular finger motion on the mouse screen. Similarly, users can zoom into a specific location by pointing the cursor in that region and sliding the finger on a soft zoom control. The dual input capability (mouse and touch) effectively eliminates the need for mode switch between pointing and gesturing, as common in many other systems.

Private Notification

Notifications of incoming emails or instant messages are sometimes distracting and may potentially reveal private information to others, especially when a system is connected to a public display (i.e. during a presentation) [17]. By setting LensMouse into private mode, messages that would normally appear on-screen will be diverted to the private mouse display. While not implemented in our current prototype, users could use simple, pre-configured gestures on the mouse screen to make rapid responses, such as “I am busy” [6].

Custom Controller

LensMouse can support numerous types of custom controls including soft buttons, sliders, pads, etc. For example, to navigate web pages, forward and back buttons can be provided, and to browse a long page a multi-speed scroll-bar can be implemented. As a custom controller, LensMouse can provide any number of controls that can fit on the display for a given application. In further embodiments, the device 10 can include the ability to automatically open a set of user-configured custom controls for a given application. For instance, upon opening a map-based application, the LensMouse could provide different lenses for pan+zoom controls, overviews, or other relevant controls.

Fluid Annotation

Annotating documents while reading can be cumbersome in a conventional desktop setup due to the separate actions of selecting the point of interest with the mouse and then typing on the keyboard [27]. LensMouse could support simple annotations (such as basic shapes) in a more fluid way. Users can move the mouse over the content of interest, and annotate with their fingertips.

In conclusion, LensMouse is a novel device that serves as auxiliary display—or lens—for interacting with desktop computers. Some key benefits of LensMouse have been demonstrated (e.g. reducing mouse travel, minimizing window management, reducing occlusion, and minimizing workspace “distortions”), as well as resolving some of the challenges with auxiliary windows on desktops. A controlled user experiment reveals a positive net gain in performance of LensMouse over certain common alternatives. Subjective user preference confirms quantitative results showing that LensMouse is a welcome addition to the suite of techniques for augmenting the mouse. Additionally, the utility of LensMouse was demonstrated through various applications, including preview and see-through lenses, gestural interaction, and others.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

### REFERENCES

The following references are incorporated herein by reference.

1. Ashdown, M., Oka, K., Sato, Y. (2005). Combining head tracking and mouse input for a GUI on multiple monitors. CHI Extended Abstracts, 1188-1191.

2. Asano, T., Sherlin, E., Kitamura, Y., Takashima, K., and Kishino, F. (2005). Predictive Interaction Using the Delphian desktop. UIST, 133-141.

3. Benko, H. and Feiner, S. (2005). Multi-Monitor Mouse. CHI Extended Abstracts, 1208-1211.

4. Baudisch, P., Cutrell, E., Hinckley, K., and Gruen, R. (2004). Mouse Ether: Accelerating the Acquisition of Targets Across Multi-Monitor Displays. CHI, 1379-1382.

5. Baudisch, P. and Gutwin, C. (2004). Multiblending: displaying overlapping windows simultaneously without the drawbacks of alpha blending. CHI, 367-374.

6. Balakrishnan, R. and Patel, P. (1998). The PadMouse: Facili-tating selection and spatial positioning for the non-dominant hand. CHI, 9-16.

7. Bi, X. and Balakrishnan, R. (2009). Comparing Usage of a Large High-Resolution Display to Single or Dual Desktop Displays for Daily Work. CHI, 1005-1014.

8. Bier, E. A., Stone, C. M., Pier, M, Buxton, W., and De-Rose, T. D. (1993). Toolglass and Magic Lenses: The See-Through Interface. SIGGRAPH, 73-80.

9. Cechanowicz, J., Irani, P., Subramanian, S. (2007). Augmenting the mouse with pressure sensitive input. CHI, 1385-1394

10. Chen, N., Guimbretière, F., Dixon, M., Lewis, C., and Agrawala, M. (2008). Navigation Techniques for Dual Display E-Book Readers. CHI, 1779-1788.

11. Dickie, C., Hart, J., Vertegaal, R., and Eiser, A. (2006). LookPoint: an evaluation of eye input for hands-free switching of input devices between multiple computers. OZCHI, 119-126.

12. Grudin, J., (2001). Partitioning digital worlds: focal and peripheral awareness in multiple monitor use. CHI, 458-465.

13. Guiard, Y., Blanch, R., and Beaudouin-Lafon, M. (2004). Object pointing: a complement to bitmap pointing in GUIs. GI, 9-16.

14. Hutchings, D. R., Smith, G., Meyers, B., Czerwinski, M., Robertson, G. (2004). Display space usage and window management operation comparisons between single monitor and multiple monitor users. AVI, 32-39.

15. Hutchings, D. R. and Stasko, J. (2005). mudibo: Multiple dialog boxes for multiple monitors. CHI Extended Abstracts, 1471-1474.

16. Hutchings, D. R. and Stasko, J. (2007). Consistency, Multiple Monitors, and Multiple Windows. CHI Extended Abstracts, 211-214.

17. Hutchings, H. M. and Pierce, J. S. (2006). Understanding the whethers, hows, and whys of divisible interfaces. AVI, 274-277.

18. Hornbaek, K., Bederson, B. B., and Plaisant, C. (2002). Navigation patterns and usability of zoomable user interfaces with and without an overview. TOHCI, 9(4), 362-389.

19. Hinckley, K., Sinclair, M., Hanson, E., Szeliski, R., and Con-way, M. (1999). The VideoMouse: a camera-based multi-degree-of-freedom input device. UIST, 103-112.

20. Hinckley, K., Cutrell, E., Bathiche, S., and Muss, T. (2002). Quantitative analysis of scrolling techniques. CHI, 65-72.

21. Hinckley, K., Dixon, M., Sarin, R., Guimbretiere, F., and Balakrishnan, R. (2009). Codex: a dual screen tablet computer. CHI, 1933-1942.

22. Ishak, E. W., Feiner, S. K. (2004). Interacting with hidden content using content-aware free-space transparency. UIST, 189-192.

23. Kobayashi, M. and Igarashi, T. (2008). Ninja Cursors: Using Multiple Cursors to Assist Target Acquisition on Large Screens. CHI, 949-958.

24. Kang, Y. and Stasko, J. (2008) Lightweight Task/Application Performance using Single versus Multiple Monitors: A Comparative Study. GI. 17-24.

25. Myers, B. A., Miller, R. C., Bostwick, B., and Evankovich, C. (2000). Extending the windows desktop interface with con-nected handheld computers. 4th USENIX Windows Systems Symposium, 79-88.

26. McGuffin, M. and Balakrishnan, R. (2002). Acquisition of expanding targets. CHI, 57-64.

27. Morris, M. R., Brush, A. J. B., and Meyers, B. (2007). Reading Revisited: Evaluating the Usability of Digital Display Surfaces for Active Reading Tasks. Tabletop, 79-86.

28. MacKenzie, S. (1992). Fitts' law as a research and design tool in human-computer interaction. Human-Computer Interaction 7(1): 91-139.

29. Nacenta, M., Mandryk, R., Gutwin, C. (2008). Targeting Across Displayless Space. CHI, 777-786.

30. Plaisant, C., Carr, D., and Shneiderman, B. (1995). Image-browser taxonomy and guidelines for designers. IEEE Soft-ware, 12(2), 21-32.

31. Pietriga, E., Appert, C., and Beaudouin-Lafon, M. (2007). Pointing and Beyond: an Operationalization and Preliminary Evaluation of Multi-scale Searching. CHI, 1215-1224.

32. Parhi, P., Karlson, A., and Bederson, B. (2006). Target size study for one-handed thumb use on small touch screen devices. MobileHCI, 203-210.

33. Ramos, G., Cockburn, A., Beaudouin-Lafon, M. and Balakrishnan, R. (2007). Pointing Lenses: Facilitating Stylus Input throughVisual- and Motor-Space Magnification, CHI, 757-766.

34. Ringel, M. (2003). When One Isn't Enough: An Analysis of Virtual Desktop Usage Strategies and Their Implications for Design. CHI Extended Abstracts, 762-763.

35. Shi, K., Irani, P, and Subramanian, S. (2009). Pressure-Move: Pressure Input with Mouse Movement, INTERACT, 25-39.

36. St. John, M., Harris, W., and Osga, G. A. (1997). Designing for multitasking environments: Multiple monitors versus multiple windows. HFES, 1313-1317.

37. Tan, D. S. and Czerwinski, Mary (2003). Effects of Visual Separation and Physical Discontinuities when Distributing Information across Multiple Displays. INTERACT, 252-260.

38. Tan, D. S., Meyers, B., and Czerwinski, M. (2004). WinCuts: Manipulating Arbitrary Window Regions for More Effective Use of Screen Space. CHI EA, 1525-1528.

39. Villar, N., Izadi, S., Rosenfeld, D., Benko, H., Helmes, J., Westhues, J., Hodges, S., Butler, A., Ofek, E., Cao, X., and Chen, B. (2009). Mouse 2.0: Multi-touch Meets the Mouse. UIST, 33-42.

40. Vogel, D. and Baudisch, P. (2007). Shift: A Technique for Operating Pen-Based Interfaces Using Touch. CHI, 657-666.

41. Ware, C. and Lewis, M. (1995). The DragMag image magnifier. CHI, 407-408.

42. Izadi, S., Hodges, 5., Taylor, S., Rosenfeld, D., Villar, N., Butler, A., and Westhues, J. (2008). Going Beyond the Display: A surface technology with an electronically switchable diffuser. UIST, 269-278.

43. Pietriga, E. and Appert, C. (2008). Sigma lenses: focus-context transitions combining space, time and translucence. CHI, 1343-1352.

1. A peripheral device for communication between a user and a computer, the peripheral device comprising:
a housing;
a tracking mechanism supported on the housing and arranged to translate a user movement into a first input signal corresponding to a movement of a cursor of the computer;
an output screen supported on the housing and arranged to display an image thereon responsive to a peripheral output signal from the computer;
a touch responsive mechanism associated with the output screen and arranged to generate a second input signal responsive to user contact with the output screen; and
electronic circuitry supported within the housing and arranged to communicate the first input signal from the tracking mechanism and the second input signal from the touch responsive mechanism to the computer and arranged to communicate the peripheral output signal from the computer to the output screen.

2. The device according to claim 1 in combination with a computer comprising a windows user interface and a primary display screen arranged to display at least one primary window to the user thereon, wherein the output screen is arranged to display an auxiliary output of the windows user interface thereon.

3. The device according to claim 2 wherein the auxiliary output comprises an inset window.

4. The device according to claim 2 wherein the auxiliary output comprises a pop-up message window.

5. The device according to claim 2 wherein the auxiliary output comprises a widget.

6. The device according to claim 2 wherein the auxiliary output comprises a toolbar.

7. The device according to claim 2 wherein said at least one primary window comprises at least one nested window and the auxiliary output is arranged to display contents of the nested window.

8. The device according to claim 7 wherein the primary window comprises a plurality of nested windows and the auxiliary output is arranged to display a selected one of the nested windows corresponding to a cursor location determined by the tracking mechanism.

9. The device according to claim 2 wherein said at least one primary window comprises a plurality of primary windows including an active primary window and at least one inactive primary window overlapped by the active primary window, the auxiliary output comprises a representation of an inactive primary window overlapped by the active primary window.

10. The device according to claim 9 wherein the auxiliary output comprises a representation of an uppermost one of a plurality of the inactive primary windows overlapped by the active primary window.

11. The device according to claim 2 wherein the auxiliary output comprises a preview window representing contents of a web link.

12. The device according to claim 2 wherein the auxiliary output comprises a magnified portion of the primary display screen corresponding to a cursor location determined by the tracking mechanism.

13. The device according to claim 2 wherein the auxiliary output comprises an interactive dialogue box.

14. The device according to claim 1 wherein the output screen is arranged to display existing information streaming from an active application of the computer.

15. The device according to claim 14 further comprising a plug-in arranged to stream auxiliary information from an active application of the computer and wherein the output screen is arranged to display said auxiliary information.

16. The device according to claim 1 wherein the touch responsive mechanism is arranged to generate the second input signal independently of the first input signal of the tracking mechanism.

17. The device according to claim 1 wherein the tracking mechanism is arranged to determine a location of a cursor of the computer and wherein the touch responsive mechanism is arranged to generate the second input signal independently of the location of the cursor such that a location of the cursor is not affected by the second input signal.

18. The device according to claim 1 wherein the first input signal of the tracking mechanism is arranged to manipulate a first aspect of a selected object of the computer and the second input signal of the touch responsive mechanism is arranged to manipulate a second aspect of the selected object independent of the first aspect.

19. The device according to claim 1 wherein the touch responsive mechanism is arranged to generate the second input signal proportionally to a user movement across the output screen.

20. The device according to claim 1 wherein the touch responsive mechanism is arranged to generate a plurality of different second input signals corresponding to different designated areas of the output screen, each of the designated areas being arranged to proportionally generate the respective second input signal responsive to a user movement across the designated area of the output screen at a different rate than the other designated areas.

21. The device according to claim 1 wherein a function of the second input signal is arranged to vary according to an active application being executed by the computer.

22. The device according to claim 1 wherein the touch responsive mechanism includes a function selection area arranged to modify the image on the output screen and a function of the second input signal responsive to user contact with the function selection area.

23. The device according to claim 1 wherein the touch responsive mechanism includes a button area arranged to generate a computer click input signal responsive to user contact with the button area.

24. The device according to claim 1 wherein the touch responsive mechanism includes a scroll area arranged to generate a scrolling input signal responsive to a user movement across the scroll area.

25. The device according to claim 1 wherein the touch responsive mechanism is arranged to generate a computer click input signal responsive to a pressure of a user contact with the output screen which exceeds a prescribed pressure threshold.

26. The device according to claim 1 wherein the housing is arranged to be supported externally of the computer.

27. The device according to claim 26 wherein the housing is arranged to support the tracking mechanism, the output screen, and the touch responsive mechanism integrally thereon for movement together relative to the computer.

28. The device according to claim 27 wherein the housing comprises a bottom side arranged for relative sliding movement along a supporting surface in which the tracking mechanism is arranged to translate the relative sliding movement into the first input signal, the output screen being arranged to extend upwardly at an inclination relative to the bottom side of the housing.

29. The device according to claim 1 in combination with the computer in which the computer is arranged to communicate with the peripheral device such that the image displayed on the output screen is not displayed on a primary display of the computer.

30. The device according to claim 1 wherein there is provided a notification system arranged to notify a user when an image on the output screen is refreshed.

31. The device according to claim 30 wherein the notification system comprises an audible notification.

32. The device according to claim 30 wherein the notification system comprises a vibrating notification.
